(19) United States
(12) Patent Application Publication
(10) Pub. No.: US 2002/0070849 A1
(43) Pub. Date: Jun. 13, 2002

(54) Signaling system for vehicles travelling in a convoy

(76) Inventors: Martin H. Teicher, Waltham, MA (US); Steven B. Lowen, Burlington, MA (US)

Correspondence Address: DALY, CROWLEY & MOFFORD, LLP, SUITE 101, 275 TURNPIKE STREET, CANTON, MA, 02021-2310, US

(21) Appl. No.: 09/732,051

(22) Filed: Dec. 7, 2000

(51) Int. Cl. B60Q 1/00

(52) U.S. Cl. 340/425.5; 340/436

(57) ABSTRACT

A signaling system for vehicles traveling in a convoy includes an external signaling system for informing nearby drivers of the convoy and an internal signaling device for communicating messages between the convoy members. Each convoy vehicle includes a signaling system. The external signaling systems can include flashing lamps that can be synchronized with other systems such that the external signaling systems for each convoy member flash at the same time. In one embodiment, the internal signaling system includes a series of buttons each for sending predetermined messages to other convoy vehicles. The internal signaling system can include a screen for displaying messages received from other convoy vehicles.

### CROSS REFERENCE TO RELATED APPLICATIONS

Not Applicable.

### STATEMENT REGARDING FEDERALLY SPONSORED RESEARCH

Not Applicable.

### FIELD OF THE INVENTION

The present invention relates generally to signaling systems, and more particularly, to vehicle signaling systems.

### BACKGROUND OF THE INVENTION

There are a variety of known systems that provide signals associated with vehicles travelling in a convoy. For example, one such system includes miniature flag holders for securing flags on a vehicle to communicate to non-convoy vehicles that the flagged vehicles are members of the convoy. More sophisticated systems include cell phones and walkie-talkies that provide verbal communication between vehicles in the convoy. Another system includes remote control for maintaining a predetermined distance between convoy members.

While each of these systems provide some level of communication, none of the systems alert other drivers that vehicles are traveling in a convoy and enable communication between the convoy members. In addition, some of these systems can have a negative safety impact since they may distract the driver's attention away from the road.

It would, therefore, be desirable to provide a signaling system that provides an indication to drivers on a roadway that vehicles are traveling in a convoy and allows communication between the convoy members.

### SUMMARY OF THE INVENTION

The present invention provides a signaling system for vehicles in a convoy that generates signals to other vehicles on a roadway indicating membership in the convoy and that allows communication between convoy vehicles. In general, the signaling system includes an external signaling device for generating signals indicating vehicle convoy membership and an internal signaling device for interfacing with a user to facilitate sending and receiving messages between the convoy vehicles. While the invention is primarily shown and described as a signaling system for vehicles in a convoy, it is understood that the invention is applicable to other systems in which is it desirable to provide signals to non-group members and to communicate messages between group members.

In one aspect of the invention, a signaling system includes an external signaling device for mounting on vehicles travelling in a convoy to generate visual signals indicating convoy membership to non-convoy vehicles. The system further includes an internal signaling device for communicating messages between the convoy members. A transmitter/receiver device can send and receive the messages. A controller coupled to the external and internal signaling devices can control the overall operation of the system.

The system can optionally include a signal detector for detecting external signals generated by the preceding convoy member. If the signal detector does not receive the external signals, the signaling system can generate a corresponding message for transmission to the preceding convoy member that the convoy has been interrupted.

In a further aspect of the invention, a method for signaling by members of a convoy includes generating a visible signal indicative of convoy membership to non-convoy members and communicating messages between convoy members. The method further can further include synchronizing the visible signals generated by the convoy members. In one embodiment, the method includes modifying a frequency of the external convoy signal based upon whether an external signal from a preceding convoy member is detected.

### BRIEF DESCRIPTION OF THE DRAWINGS

The invention will be more fully understood from the following detailed description taken in conjunction with the accompanying drawings, in which:

FIG. 1 shows a block diagram of a signaling system for vehicles traveling in a convoy in accordance with the present invention;

FIG. 2 is a pictorial representation of a signaling system in accordance with the present invention;

FIG. 3 is a schematic depiction of an internal signaling device that can form a part of a signal system in accordance with the present invention; and

FIG. 4 is a further pictorial representation of a first and second convoy vehicles utilizing signaling systems in accordance with the present invention.

### DETAILED DESCRIPTION OF THE INVENTION

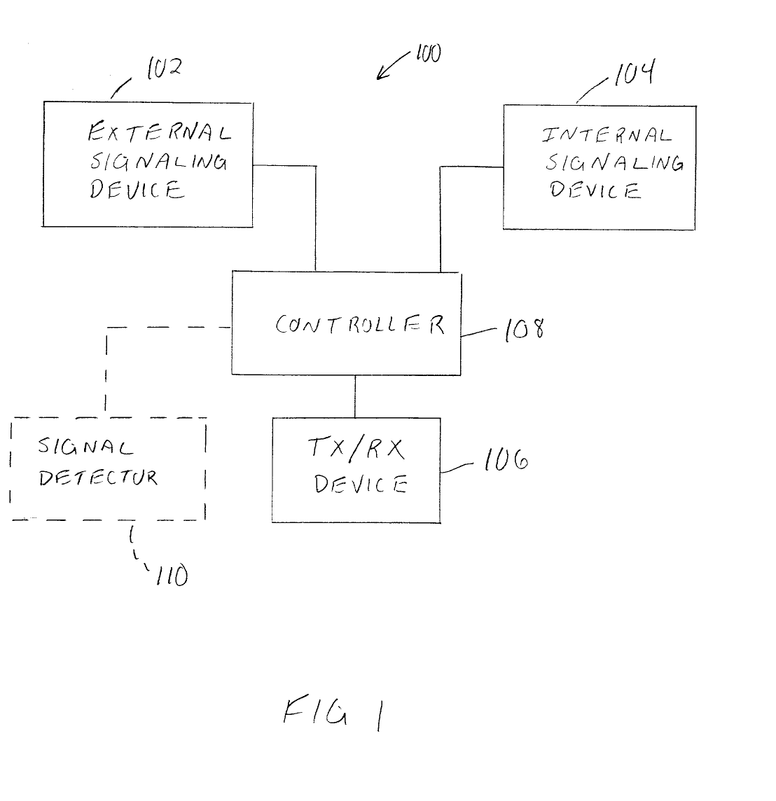

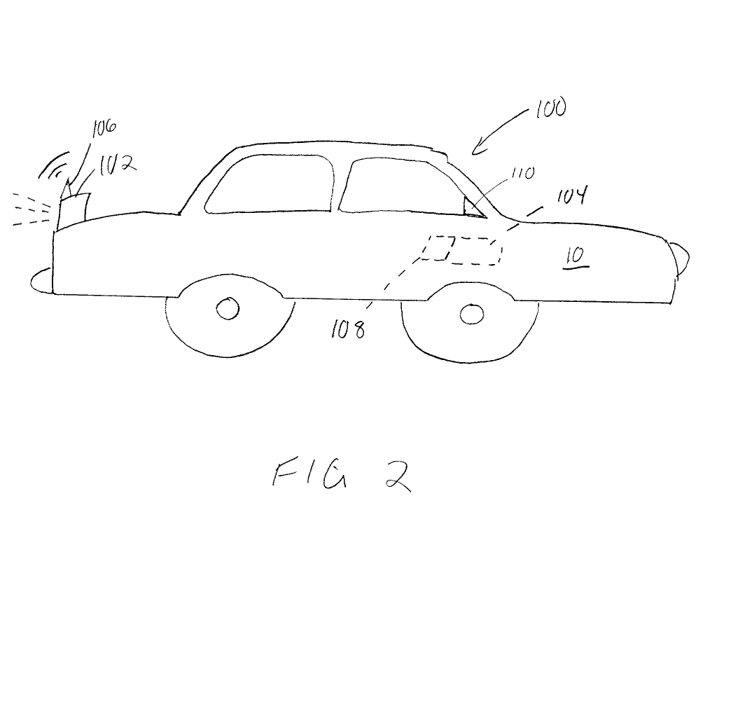

FIGS. 1 and 2 show a signaling system 100 for vehicles traveling in a convoy in accordance with the present invention. In general, each convoy member includes a signaling system. The system 100 includes an external signaling device 102 mounted on a first vehicle 10 for generating visible signals to non-convoy members to indicate that the first vehicle is a member of the convoy. An internal signaling device 104 facilitates message communication between convoy members. The messages can be sent and received by a transmit/receive device 106. In one embodiment, a controller 108 controls the overall operation of the signaling system.

The external signaling device 102 can generate a variety of signal types that are visible to drivers on a roadway. Exemplary signals include flashing lights, alphanumeric displays, rotating lamps, and colored lamps that can change in color, lamp arrays that turn off and on in a pattern and lamps that change intensity in varying speeds. Further types of visible signals will be readily apparent to one of ordinary skill in the art.

In an illustrative embodiment, the external signaling device 102 includes a series of colored, e.g., red, lamps that can be flashed at a desired rate and signal pattern. In one particular embodiment, the external signaling device 102 comprises a series of adjacent lamps similar to conventional brake lights. The lamps can be flashed on and off at a selected frequency. It is understood that the external signaling device can include a plurality of panels containing lamps to increase the angle from which emitted signals can be seen by other drivers on the roadway.

The external signaling device 102 should be mounted on a vehicle so as to maximize the ability of other drivers on a roadway to see the signals generated by the device. Illustrative locations on which the external signaling device can be mounted on a vehicle include on the roof, on the trunk, on the rear window (either side), on or near the side windows, on the doors, on the bumper, and on a pole extending from the vehicle. It is understood that the external signaling device provides external signals that are visible to other drivers regardless of the location of the device. That is, the external signaling device can be disposed within a vehicle, such as adjacent a window, provided that the emitted signal can be easily seen by other drivers on a roadway.

The internal signaling device 104 allows convoy members to send and receive messages to each other. The internal signaling device 104 can include a variety of components and interfaces that enable an operator or passenger of a convoy vehicle to communicate with other convoy vehicles. Exemplary signaling devices include a display screen, an alphanumeric keypad, a touchscreen, message buttons, sound amplifiers, microphones, and mouse. It is understood that messages can be provided in audible and/or visible formats. It is further understood that a particular component can be selected based upon the requirements of a particular application, including cost and ease of use.

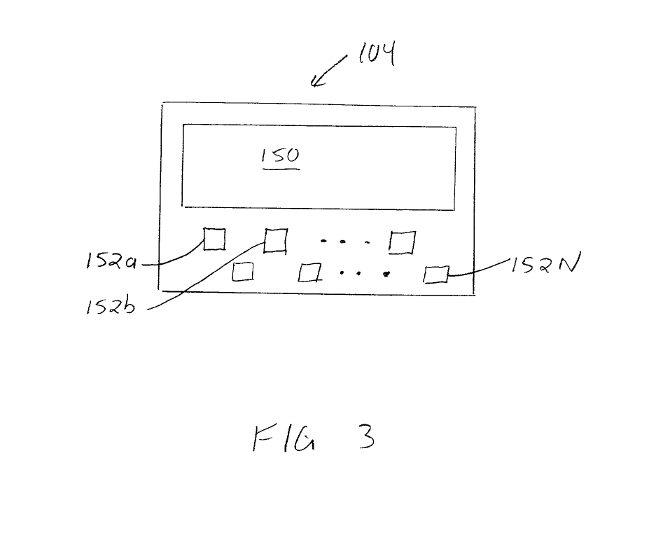

FIG. 3 shows one particular embodiment of an internal signaling device 104 including a graphical display 150 for showing relatively small textual messages. The device 104 further includes a plurality of buttons 152a-N each of which corresponds to a predetermined message. That is, to send a particular message, a user pushes the corresponding button. Upon receiving a message, the internal signaling device can beep to indicate receipt of a message. Alternatively, the internal signaling device can generate speech corresponding to the message.

Exemplary stored messages for transmission by a non-lead convoy vehicle include please stop, please slow down, please drive carefully, visual lost. Exemplary stored messages for transmission by the lead convoy vehicle include please move back, please move closer, and beware hazard.

Referring again to FIGS. 1-2, the transmit/receive device 106 can achieve message communication between signaling systems using a variety of technologies. For example, wireless communication can be used in unlicensed portions of the radio spectrum, such as ISM bands 900 MHz, 2.4 GHz, 5.8 GHz, and 24 GHz, PCS bands at 1.9 MHz, and NII bands at 5.2 MHz and 5.8 MHz. In one particular embodiment, a walkie-talkie type system includes a “touch-to-talk” button. The use of unlicensed portions of the radio spectrum for low power localized communication is well known to one of ordinary skill in the art. Further relatively short-range technologies that can provide message communication in the present invention include so-called Bluetooth technology. As known to one of ordinary skill in the art, Bluetooth refers to integrated circuits and protocols widely used in portable devices, such as cell phones, personal digital assistants (PDAs) and laptop computers. Further signal forms can be used including ultrasonic signals, magnetic signals, infrared signals, laser signals, and other types of electromagnetic radiation.

In one particular embodiment, messages are transmitted and received at a relatively low unlicensed frequency, such as about 900 MHz. Since the range of operation is relatively short, e.g., about one mile, messages can be transmitted at low power levels. In addition, the data transmission rate can be relatively low so as to require a relatively narrow frequency band and increase transmission reliability.

In an exemplary embodiment, a first signaling system transmits signals at a first frequency and a second signaling system receives signals at the first frequency. Similarly, the first signaling system receives signals transmitted by the second signaling system at a second frequency. That is, pairs of signaling systems use one frequency for communicating in one direction and another frequency for communicating in the other direction.

To prevent interference from other signaling systems unassociated with a particular convoy, each signaling system can transmit messages having a header containing a code assigned to pairs of devices. Messages without the requisite header codes are ignored.

In one embodiment, the transmit/receive device 106 system transmits a signal at a frequency corresponding to the external signaling device 104 for synchronizing lamp flashing for each signaling system in the convoy. In this way, a car near the convoy will see each convoy member generating the same signal at the same time. This provides an indication to drivers that the vehicles are travelling in a convoy and should not be interrupted.

In general, the transmit/receive device 106 can be disposed on a wide range of locations on a vehicle. The device 106 should be placed so as to ensure an adequate level of signal integrity for a predetermined range given the particular characteristics of the transmitted signal. In one embodiment, the transmit/receive device 106 is disposed on the external signaling device 104.

In a further feature of the invention, each signaling system 100 detects message traffic generated by other signaling systems that are not part of the present convoy. The signaling system then adjusts the external signaling frequency away from the flash frequency of the other systems.

The convoy signaling system 100 can optionally include a signal detector 110 for detecting visible signals generated by the preceding convoy member. In one embodiment, the signal detector includes a light detector, e.g., photodiodes, phototransistors, and photo resistive elements including cadmium sulfide, for detecting light of the type generated by the external signaling device 104. Such devices are well known to one of ordinary skill in the art. The detected signal can be filtered so as to limit detection to signals within a predetermined frequency corresponding to the external signal frequency range. The signal detector 110 can be used to synchronize the external signal devices 102 such that the lamps flash simultaneously at each convoy vehicle. In addition, the lamp signal frequency can be modified depending upon whether signals from the preceding convoy vehicle are detected. For a convoy having more than two vehicles, the external signaling devices in front of and in back of a vehicle that has interrupted the convoy can flash at an increased frequency as compared to the frequency of the external signaling devices on the other convoy vehicles. In an alternative embodiment, the signaling frequency of each external signaling device can change when one convoy vehicle detects an interruption.

In another feature of the invention, the signaling system can determine direction and/or heading information of other convoy vehicles, such as the lead vehicle, from received signals. Directional antennas can be mounted on the vehicle to enable direction/heading information to be determined. Alternatively, the system can include global positioning system (GPS) for providing the location of the vehicle. Coordinate information can be exchanged between vehicles. In an exemplary embodiment, each vehicle can appear on a display screen, which can include a map, based upon the GPS information.

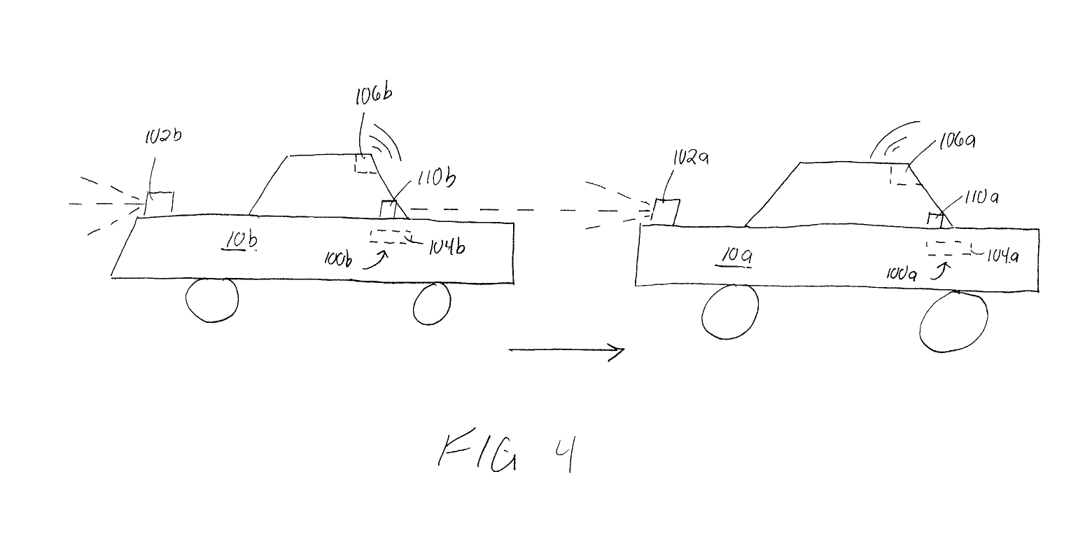

FIG. 4 shows first and second vehicles 10a,b traveling in a convoy, i.e., in tandem, in which like reference numbers indicate like elements. The first vehicle 10a includes a first signaling system 100a in accordance with the present invention and the second vehicle 10b has a second signaling system 100b. The external signaling device 102a of the first signaling system 100a generates a visual signal that is detected by the signal detector 110b of the second signaling system 10b. The external signaling systems 102a,b of the vehicles generate signals, e.g., flash lamps, at a predetermined frequency, such as at about two Hz. The lamp flashing of the external devices 102 can be synchronized by signals transmitted between the two vehicles, as described above. In one embodiment, the flash frequency of the second external signaling device 102b can increase, such as to about five Hz, in the event the signal detector 110b on the second vehicle 10b is not detecting signals from the first external signaling device 102a, e.g., a car has moved between the first and second vehicles 10a,b. Alternatively, one of the external signaling devices can control the lamps such that they gradually transition from on to off or from off to on.

The first and second vehicles 10a,b can exchange predetermined messages by hitting the corresponding button on the internal signaling devices 104a,b as described above. The messages are communicated between the transmit/receive devices 106a,b of the signaling systems 100a,b.

The present invention provides a system for signaling other vehicles on a roadway that vehicles are traveling in a convoy and for exchanging messages between convoy members. The system reduces the occurrence of drivers interrupting the convoy and allows communication between vehicles in a convoy.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A signaling system for vehicles traveling in a convoy including first and second vehicles, comprising:
an external signaling device for mounting on a first vehicle to signal other vehicles that the first vehicle is traveling with the convoy;
an internal signaling device disposed on the first vehicle for communicating messages between the first and second vehicles;
a transmit/receive device for transmitting and receiving the messages communicated between the first and second vehicles; and
a controller coupled to the external signaling system, the internal signaling system, and the transmit/receive device for controlling operation of the signaling system.

2. The system according to claim 1, wherein the external signaling system includes at least one light-emitting element.

3. The system according to claim 2, further including a signal detector for detecting signals generated by an external signaling device on the second vehicle.

4. The system according to claim 1, wherein the transmit/receive device can provide a two-way radio link.

5. The system according to claim 1, wherein the transmit/receive device provides two-way communication utilizing signals from the group consisting of RF signals, microwave signals, optical signals, audio signals, ultrasonic signals, magnetic signals, laser signals and infrared signals.

6. The system according to claim 1, wherein the internal signaling device includes at least one interface mechanism for generating the messages transmitted to the second signaling system.

7. The system according to claim 6, wherein the at least one interface mechanism includes a plurality of buttons each corresponding to predetermined messages.

8. The system according to claim 1, wherein the at least one interface mechanism includes a display device for displaying received messages from the second vehicle.

9. The system according to claim 1, wherein the controller determines a signaling frequency of the external signaling device.

10. The system according to claim 1, wherein the external signaling device on the first vehicle can be synchronized with a further external signaling device on the second vehicle.

11. A system for signaling by first and second vehicles in a convoy, comprising:
first and second signaling systems each including
an external signaling device for generating external signals visible to other drivers on a roadway indicating that the first and second vehicles are members of the convoy;
an internal signaling device for communicating messages between the first and second vehicles;
a transmit/receive device for sending and receiving the messages between the first and second vehicles; and
a controller for controlling operation of the signaling system.

12. The system according to claim 11, wherein the first and second signaling systems further include a signal detector for detecting signals generated by the external signaling devices.

13. The system according to claim 11, wherein the external signaling devices include a plurality of lamps.

14. The system according to claim 11, wherein the internal signaling devices include buttons corresponding to predetermined messages.

15. A method for first and second vehicles traveling in tandem to communicate, comprising:
generating a visible signal from a first external signaling device on the first vehicle and a second visible signal from a second external signaling device on the second vehicle to inform other drivers that the first and second vehicles are driving in tandem; and
communicating messages between the first and second vehicles via a first internal signaling device in the first vehicle and a second internal signaling device in the second vehicle.

16. The method according to claim 15, further including modifying a signaling frequency of the second external signaling device when a signal from the first external signaling device is not detected.

17. The method according to claim 15, further including synchronizing signals generated by the first and second external signaling devices.

18. The method according to claim 17, further including transmitting signals corresponding to the external signaling device signals.

19. The method according to claim 15, further including sending predetermined messages by actuating an interface device on the internal signaling devices.

20. The method according to claim 15, further including communicating the messages between the first and second vehicles via a signal of a type selected from the group consisting of RF signals, microwave signals, optical signals, audio signals, ultrasonic signals, magnetic signals, laser signals and infrared signals.

21. The method according to claim 15, further including communicating with further vehicles travelling in tandem with the first and second vehicles.

22. The method according to claim 15, further including communicating at least one of direction and heading from the first vehicle to the second vehicle.
